(19) United States
(12) Patent Application Publication
(10) Pub. No.: US 2009/0127940 A1
(43) Pub. Date: May 21, 2009

(54) Linear motor

(75) Inventors: Dieter Profunser, Feldkirch (AT); Chafic Abu Antoun, Buchs (CH)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/290,996

(22) Filed: Nov. 4, 2008

(30) Foreign Application Priority Data
Nov. 21, 2007 (DE) 10 2007 055 499.2

(51) Int. Cl. H02K 41/02

(52) U.S. Cl. 310/12

(57) ABSTRACT

A linear motor (1) has a rotor (2) which is mounted so as to be guided in an axially reciprocating manner in a stator (4) having at least one coil (5) with a plurality of windings (6), with at least one winding (6) forming a cooling rib (8, 8′, 8″) open at the edges.

### BACKGROUND OF THE INVENTION

1. Field of the Invention

The present invention relates to a linear dynamo-electric machine for driving a rotor in a reciprocating manner, particularly a linearly unrolled permanent magnet stepper motor or reluctance motor (hereinafter, linear motor) for driving an electric hand-held power tool such as a chisel hammer.

2. Description of the Prior Art

A linear motor includes a rotor which is supported so as to be guided in an axially reciprocating manner in an axially toothed stator. In the case of an unrolled permanent magnet stepper motor, the rotor has axially alternating permanent magnet poles; in the case of an unrolled reluctance motor, the rotor is also axially toothed; there are also forms in which these two motors are combined. The stator has at least one coil through which current flows so as to generate a magnetic flux that penetrates the stator and rotor so that the driving forces are excited.

In many applications, linear motors are used as actuators, i.e., their operation is interrupted again and again by rest phases during which they can cool down. When used for sustained driving of a high-power electric hand-held power tool with limited machine volume, drive outputs of more than 1000 W are needed, which requires high flux densities and high currents (>100A) to generate the latter. The coil is intensely heated because of resistance losses and induction losses and must be cooled.

According to German Publication DE 100 55 078, in a compact linear motor in the form of an unrolled reluctance motor with an axially reciprocating rotor disposed coaxially therein, the axially toothed stator has two coils which are ring-shaped with a small edge surface (in the cross section of the coil).

In a low-power linear motor in the form of an unrolled permanent magnet stepper motor according to JP 2003 009503, the stator located on the inner side has a foil coil whose individual windings directly form cooling ribs which are completely enclosed by a hollow-profile-shaped armature and a cooling air flow flows through it. The linear motor serves as the positioning drive of a coordinate table. The areas of the winding charged with the cooling function are guided out of the stator and spread by bending so that the cooling air flow can be guided between them. Accordingly, the copper windings are necessarily longer than a conventional winding construction. This embodiment of a compact motor with foils which are unstable per se is not suitable for driving a high-power electric hand-held power tool, particularly one that vibrates. Further, an induced magnetic field acts on the windings that are spread by bending, which leads to a dynamic constant flexural stress under alternating loads and can therefore result in breakage. Finally, depending on winding position, the required bending causes different winding cross-sections and bending operations which makes production of large piece numbers uneconomical.

### SUMMARY OF THE INVENTION

It is the object of the invention to realize a high-power linear motor with efficient cooling.

Another object of the invention is an economical manufactured high-power linear motor.

This and other objects of the present invention, which will become apparent hereinafter, are achieved by providing a linear motor having a rotor which is mounted so as to be guided in an axially reciprocating manner in a stator having at least one coil with a plurality of windings, with at least one winding forming a cooling rib which is (mostly) open at the edges.

Because of the cooling ribs which are open at the edges and formed directly from the windings which lie one on top of the other, the waste heat caused by high currents can be guided away in a suitable manner by an air flow even in high-power linear motors of compact construction. Further, all bending operations are eliminated from production.

In an advantageous manner, the cooling rib at the stator is at least partly open at the outside so that the good circulation of air present at that location can be used.

Advantageously, the windings which, also advantageously, comprise conductive copper are constructed as inherently rigid sheet metal so that they have only minor natural vibrations even during vibrations of the linear motor and are therefore always insulated from one another (by the air).

The cooling ribs are advantageously tapered toward the outside and are formed of a plurality of partly overlapping windings so that they are adapted to the amount of heat to be carried away with respect to the thermal conduction cross section.

At a given winding spacing (including insulating layer), the cooling ribs advantageously have a projecting height corresponding to a maximum of 15-times the winding spacing or, more advantageously, between 3-times and 4-times the winding spacing so that they are sufficiently resistant to bending.

At a given winding spacing (including insulating layer), the cooling ribs are advantageously at a distance from one another corresponding to between one-times and 10-times the winding spacing, more advantageously between 1.5-times and 2-times the winding spacing, so that they are sufficiently adapted to the heat flow of an air flow.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The invention will be described more fully with reference to an advantageous embodiment example.

The drawings show:

FIG. 1 a longitudinal cross-sectional view of a linear motor according to the present invention;

FIG. 2 a transverse cross-sectional view of the linear motor shown in FIG. 1;

FIG. 3 a cross-sectional view of a winding of a linear motor; and

FIG. 4 a cross-sectional view of another embodiment of the winding of a linear motor.

### DETAILED DESCRIPTION OF THE PREFERRED EMBODIMENTS

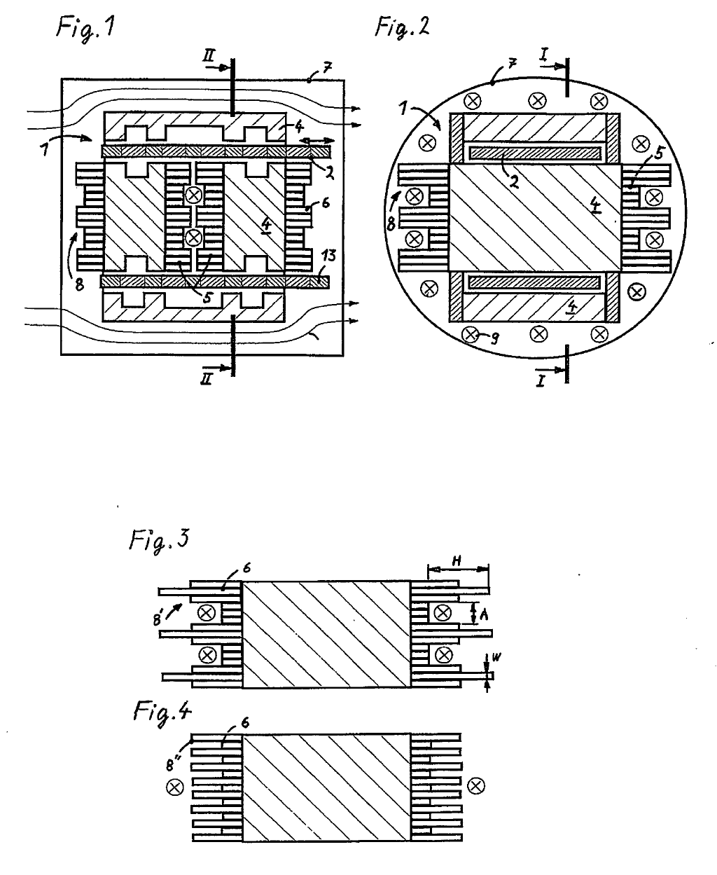

According to FIGS. 1 and 2, a linear motor 1 has a rotor 2 with alternating permanent magnets 3 which is mounted so as to be guided in an axially reciprocating manner in a partially external, axially toothed stator 4 of soft iron. The stator 4 has two coils 5 with a plurality (in this case 13) of windings 6 of conductive copper in the form of inherently rigid sheet metal. Some of the windings 6 form a cooling rib 8 which is (mostly) open at the edges and which juts out from the stator 4 and is cooled by an air flow 10 directly at the windings 6. Every three adjacent windings 6 together alternately form a cooling rib 8 or do not. The linear motor 1 arranged in a machine housing 7 is cooled by an air flow 9 directly at the windings 6. Further, there is a cross-flowing air flow 9 between the two coils 5.

In the variant shown in FIG. 3, the cooling rib 8′ tapers toward the outside in that it is formed of three partially overlapping windings 6. At a winding spacing W of 2 mm given by the sheet metal thickness (including insulating layer), the cooling ribs 8 have a projecting height H corresponding to 10-times the winding spacing W and a distance A corresponding to 3-times the winding spacing W.

According to the variant shown in FIG. 4, every second winding 6 forms a cooling rib 8′ formed of precisely one outwardly projecting winding 6. Though the present invention was shown and described with references to the preferred embodiments, such are merely illustrative of the present invention and are not to be construed as a limitation thereof and various modifications of the present invention will be apparent to those skilled in the art. It is, therefore, not intended that the present invention be limited to the disclosed embodiments or details thereof, and the present invention includes all variations and/or alternative embodiments within the spirit and scope of the present invention as defined by the appended claims.

What is claimed is:

1. A linear motor, comprising a stator (4) having at least one coil (5) with a plurality of windings (6), with at least one winding (6) forming a cooling rib (8, 8′, 8″) which is open at edges thereof; and a rotor (2) mounted so as to be guided in an axially reciprocating matter in the stator (4)

2. A linear motor according to claim 1, wherein the cooling rib (8, 8′, 8″) at the stator (4) is at least partly open at the outside.

3. A linear motor according to claim 1, wherein the windings (6) form a plurality of cooling ribs formed of inherently rigid sheet metal.

4. A linear motor according to claim 3, wherein the cooling ribs (8′) are tapered toward outside and are formed of a plurality of partly overlapping windings (6).

5. A linear motor according to claim 1, wherein at a given winding spacing (W), the cooling rib (8, 8′, 8″) has a projecting height (H) corresponding to a maximum of 15-times the winding spacing (W).

6. A linear motor according to claim 3, wherein at a given winding spacing (W), the cooling ribs (8, 8′, 8″) are spaced by a distance (A) from one another corresponding to between 1-time and 10-times of the winding spacing (W).

7. A linear motor according to claim 1, wherein the linear motor is arranged in a machine housing (7) through which an air flow (10) can flow.
